(19) United States
(12) Patent Application Publication
(10) Pub. No.: US 2013/0243201 A1
(43) Pub. Date: Sep. 19, 2013

(54) EFFICIENT CONTROL OF SOUND FIELD ROTATION IN BINAURAL SPATIAL SOUND

(71) Applicant: THE REGENTS OF THE UNIVERSITY OF CALIFORNIA, (US)

(72) Inventors: V. Ralph Algazi, Davis, CA (US); Richard O. Duda, Menlo Park, CA (US)

(73) Assignee: THE REGENTS OF THE UNIVERSITY OF CALIFORNIA, Oakland, CA (US)

(21) Appl. No.: 13/776,556

(22) Filed: Feb. 25, 2013

Related U.S. Application Data
(60) Provisional application No. 61/602,454, filed on Feb. 23, 2012.

(51) Int. Cl. H04R 5/027

(52) U.S. Cl. CPC H04R 5/027
USPC 381/17

(57) ABSTRACT

A sound reproduction method and apparatus for determining the desired orientation of the listener's head in a sound field. The method includes the steps of receiving input signals representative of output signals from a plurality of microphones positioned at a location to sample a sound field at points representing possible locations of a listener's left and right ears if said listener was positioned in said sound field at said location, and processing the input signals to generate a composite signal that simulates a rotation of the sound field about the listener's head.

### CROSS-REFERENCE TO RELATED APPLICATIONS

This application is a nonprovisional of U.S. provisional patent application Ser. No. 61/602,454 filed on Feb. 23, 2012, incorporated herein by reference in its entirety.

This invention is also related to U.S. Pat. No. 7,333,622 “Dynamic Binaural Sound Capture and Reproduction” issued on Feb. 19, 2008, incorporated herein by reference in its entirety.

### STATEMENT REGARDING FEDERALLY SPONSORED RESEARCH OR DEVELOPMENT

This invention was made with Government support under Grant Nos. IIS-00-97256 and Grant No. ITR-00-86075, awarded by the National Science Foundation. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to spatial sound capture and reproduction, and more particularly to methods and systems for capturing and reproducing the dynamic characteristics of three-dimensional spatial sound.

2. Description of Related Art

There are a number of alternative approaches to spatial sound capture and reproduction, and the particular approach used typically depends upon whether the sound sources are natural or computer-generated.

Surround sound (e.g. stereo, quadraphonics, Dolby® 5.1, etc.) is by far the most popular approach to recording and reproducing spatial sound. This approach is conceptually simple; namely, put a loudspeaker wherever you want sound to come from, and the sound will come from that location. In practice, however, it is not that simple. It is difficult to make sounds appear to come from locations between the loudspeakers, particularly along the sides. If the same sound comes from more than one speaker, the precedence effect results in the sound appearing to come from the nearest speaker, which is particularly unfortunate for people seated close to a speaker. The best results restrict the listener to staying near a fairly small “sweet spot.” Also, the need for multiple high-quality speakers is inconvenient and expensive and, for use in the home, many people find the use of more than two speakers unacceptable.

There are alternative ways to realize surround sound to lessen its limitations. For example, home theater systems typically provide a two-channel mix that includes psychoacoustic effects to expand the sound stage beyond the space between the two loudspeakers. It is also possible to avoid the need for multiple loudspeakers by transforming the speaker signals to headphone signals, which is the technique used in the so-called Dolby® headphones. However, each of these alternatives also has its own limitations.

Surround sound systems are good for reproducing sounds coming from a distance, but are generally not able to produce the effect of a source that is very close, such as someone whispering in your ear. Finally, making an effective surround-sound recording is a job for a professional sound engineer; the approach is unsuitable for teleconferencing or for an amateur.

Binaural capture is another approach. Two-channel binaural or “dummy-head” recordings, which are the acoustic analog of stereoscopic reproduction of 3-D images, have been used to capture spatial sound. The primary source of information used by the human brain to perceive the spatial characteristics of sound comes from the pressure waves that reach the eardrums of the left and right ears. If these pressure waves can be reproduced, the listener should hear the sound exactly as if he or she were present when the original sound was produced.

The pressure waves that reach the ear drums are influenced by several factors, including (a) the sound source, (b) the listening environment, and (c) the reflection, diffraction and scattering of the incident waves by the listener's own body. If a mannequin having exactly the same size, shape, and acoustic properties as the listener is equipped with microphones located in the ear canals where the human ear drums are located, the signals reaching the eardrums can be transmitted or recorded. When the signals are heard through headphones (with suitable compensation to correct for the transfer function from the headphone driver to the ear drums), the sound pressure waveforms are reproduced, and the listener hears the sounds with all the correct spatial properties, just as if he or she were actually present at the location and orientation of the mannequin. The primary problem is to correct for ear-canal resonance. Because the headphone driver is outside the ear canal, the ear-canal resonance appears twice; once in the recording, and once in the reproduction. This has led to the recommendation of using so-called “blocked meatus” recordings, in which the ear canals are blocked and the microphones are flush with the blocked entrance. With binaural capture, and, in particular, in telephony applications, the room reverberation sounds natural. It is a universal experience with speaker phones that the environment sounds excessively hollow and reverberant, particularly if the person speaking is not close to the microphone. When heard with a binaural pickup, awareness of this distracting reverberation disappears, and the environment sounds natural and clear.

Still, there are problems associated with binaural sound capture and reproduction. They include (a) the inevitable mismatch between the size, shape, and acoustic properties of a mannequin and any particular listener, including the effects of hair and clothing, (b) the differences between the eardrum and a microphone as a pressure sensing element, and (c) the influence of non-acoustic factors such as visual or tactile cues on the perceived location of sound sources.

### BRIEF SUMMARY OF THE INVENTION

The present invention includes a system and method for producing a strong illusion that a sound field, heard over headphones, is rotating around the listener. The present invention has at least two important advantages: 1) it provides a simple method for producing the rotation, and 2) it greatly reduces the computational requirements. While traditional binaural sound makes use of two real or virtual microphones positioned at the ears of a mannequin, the invention uses several microphones and signal processing procedures to allow the perceived binaural sound field to be positioned to any azimuth with respect to the listener or to be rotated continuously.

One aspect comprises a simple and computationally efficient system and method for producing a powerful sound affect for a listener wearing headphones, namely, a compelling illusion that all of the sources of sound are rotating around the listener's head. The rotation can be clockwise or counterclockwise, and can easily be controlled to a new desired orientation or to have any desired speed, constant or changing. The system can be used with or without a head tracker, as shown in the signal processing methods described in U.S. Pat. No. 7,333,622, “Binaural Sound Capture and Reproduction.”

The system and method of the present patent invention control the orientation of a binaural sound field by means other than the rotation of the listener's head to rotate the spatial sound about a listener, whether or not head rotation is taking place.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of an embodiment of a binaural sound field rotation control system according to the present invention.

FIG. 2 is a schematic diagram of an embodiment of the system shown in FIG. 1 configured for recording and playback.

FIG. 3 is a schematic diagram of the microphone array of FIG. 1.

FIG. 4 is a schematic diagram of the listener and headphone shown in FIG. 1.

FIG. 5 shows a flow diagram of a linear filtering method in accordance with the present invention.

FIG. 6 is a block diagram showing an embodiment of signal processing associated with the method of head tracking illustrated in FIG. 5.

### DETAILED DESCRIPTION OF THE INVENTION

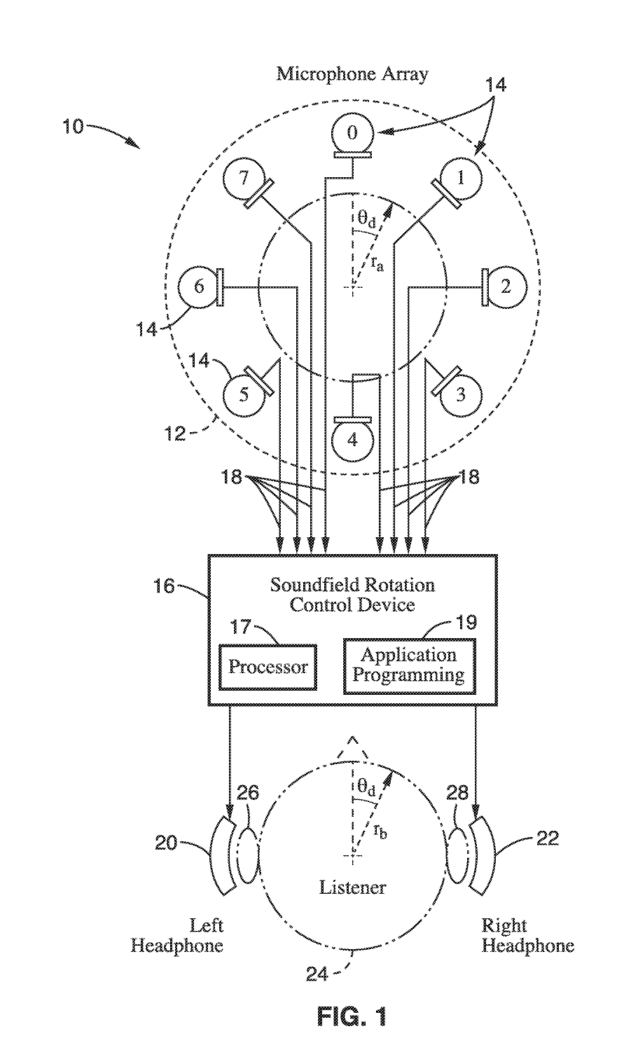

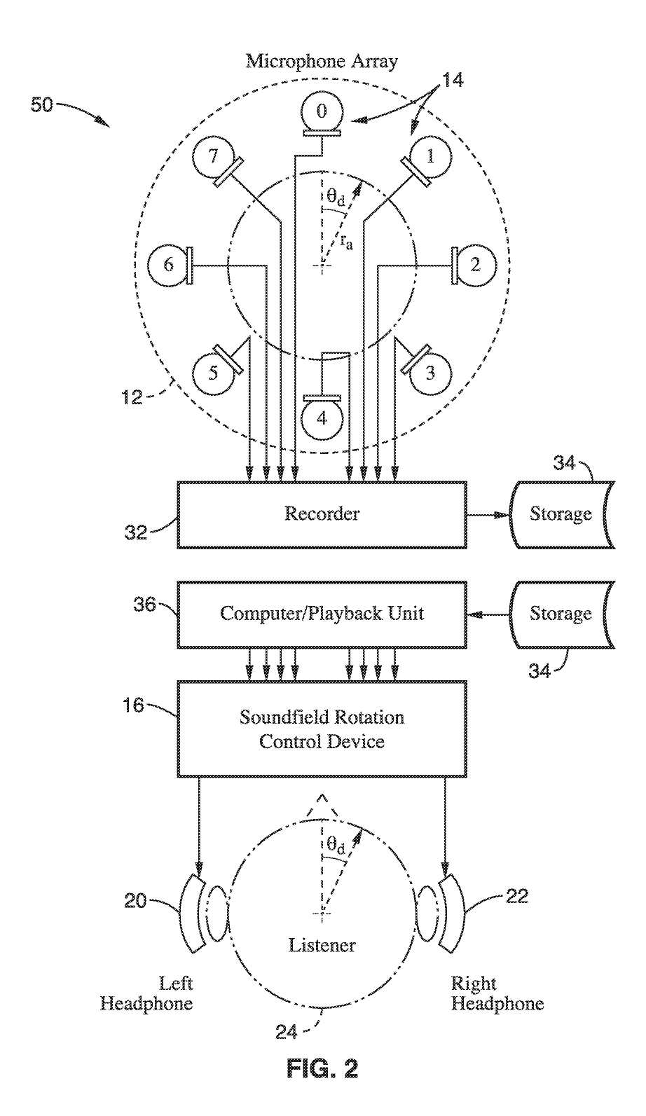

FIG. 1 shows an embodiment of a binaural sound field rotation control system 10 according to the present invention. In the embodiment shown, the system comprises a circular-shaped microphone array 12 having a plurality of microphones 14, a signal processing unit, or more particularly, a sound field rotation control device 16, coupled to the microphones via lines 18, and an audio output device (e.g. speakers such as left 20 and right 22 headphones). Control device 16 comprises signal processing application software executable on a processor (e.g. computer, playback unit 36 shown in FIG. 2).

The microphone arrangement 12 shown in FIG. 1, FIG. 2 and FIG. 4 is called a “panoramic” configuration. It is appreciated that the systems and methods of the present invention may be applied to different classes of applications, e.g. omni-directional, panoramic, and focused applications. By way of example only, the invention as illustrated in the following discussion is shown in a configuration for a panoramic application.

In the embodiment shown in FIG. 1 and FIG. 2, microphone array 12 comprises eight microphones 14 (numbered 0 to 7) equally spaced around a circle whose radius rₐ is approximately the same as the radius r_{b} of a listener's head 24. It should be appreciated that an object of the invention is to give the listener the impression that he or she is (or was) actually present at the location of the microphone array. In order to do so, the circle around which the microphones are placed should ideally be approximate the size of a listener's head.

Eight microphones are used in the embodiment shown in FIG. 1 and FIG. 2. In this regard, it is to be appreciated that the system 10 can function with as few as two microphones 14, as well as with a larger number of microphones. An embodiment using an array 12 of only two microphones 14, however, does not yield as real a sensory experience as with eight microphones, producing its best effects for sound sources that are close to the interaural axis. Correspondingly, while an array 12 having more than eight microphones 14 can be used, eight is a convenient number, since recording equipment with eight channels is readily available.

Before describing how sound field rotation control device 16 combines the microphone signals to account for head rotation, it should be noted that FIG. 1 and FIG. 2 depict the microphone outputs 18 directly feeding into sound field rotation control unit 16 for signal processing. In a preferred embodiment, sound field rotation control unit 16 may comprise a processor 17 and application programming 19 for generating the rotating sound field. However, this direct connection is shown for illustrative purposes only, and need not reflect the actual configuration used.

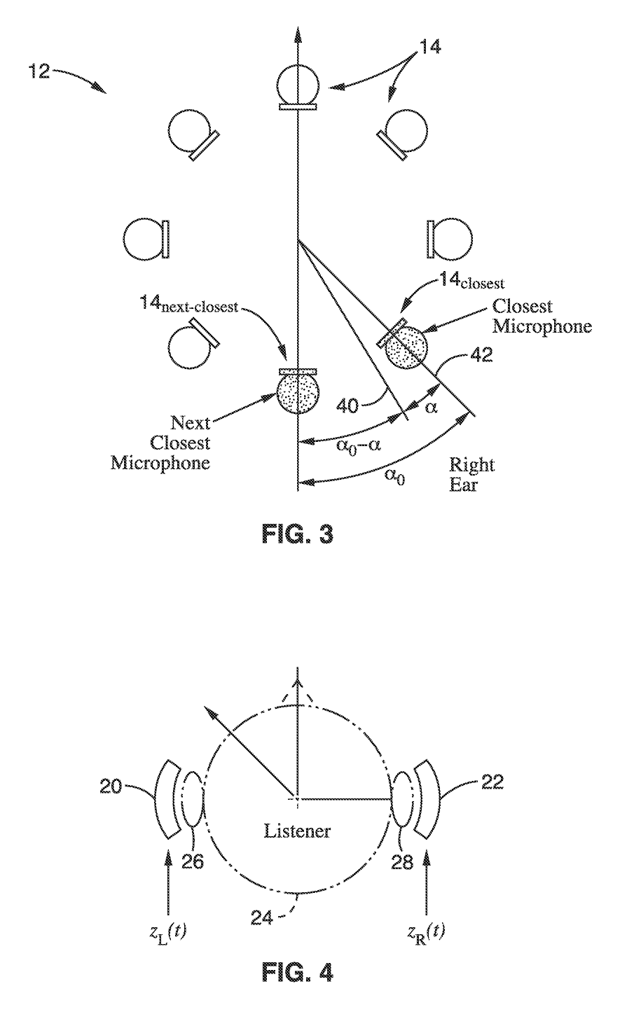

FIG. 3 illustrates a schematic diagram of a binaural sound field rotation control system 50 having a recording configuration. In this configuration, the microphone outputs 18 feed into a recording unit 32, which stores the recording on a storage media 34 such as a disk, tape, a memory card, CD-ROM or the like. For later playback, the storage media is accessed by a computer/playback unit 36, which feeds into sound field rotation control device 16.

In another embodiment (not shown), binaural sound field rotation control system may be used in a teleconferencing configuration using a multiplexer/transmitter unit that transmits the signals to a remotely located demultiplexer/receiver unit over a communications link, which may be a wireless link, optical link, telephone link or the like. The result is that the listener experiences the sound picked up from the microphones as if the listener was actually located at the microphone location.

In both the embodiments shown in FIG. 1 and FIG. 2, the binaural sound field rotation control unit 16 will generally include an audio input (not shown) to receive lines 18. The input can be in any conventional form, such as a jack, wireless input, optical input, hardwired connection, and so forth. The same is true with regard to the audio output, which is coupled to speakers 20, 22. Thus, it will be appreciated that connections between sound field rotation control unit 16 and other devices, and the “input” and “output” as used herein, are not limited to any particular form.

The signals produced by the eight microphones 14 are combined in the sound field rotation control unit 16 to produce two signals that are directed to the left 20 and right 22 headphones. For example, with the listener's head in the orientation shown in FIG. 1, the signal from microphone #6 may be sent to the left ear 26, and the signal from microphone #2 would be sent to the right ear 28. This would be essentially equivalent to what is done with standard binaural recordings.

With respect to the head 24 of the listener, the sound field as reproduced over headphones 20, 22 is actually moving with the motion of the listener's head 24. It is the synchrony of the captured sound field with the motion of the listener's head 24 that recreates over headphones the dynamic cues that result in the perception of a stable acoustic space.

The sound field rotation control device 16 may be a physical device responding to the output of a sensor, or a virtual device, such as the output of a computational algorithm. The sound field rotation control device 16 may also comprise a combination of several partial controls, such as a head tracker and another sensor. In the case where head-tracking is used in conjunction with other inputs, the listener may benefit from the dynamic cues produced by head rotation while listening to a moving sound field.

For purposes of the present invention, the listener 24 is motionless and listens to the output of the microphone array 12, as processed by the signal-processing unit 16. The microphone array 12 converts acoustic sound waves that arrive from a sound source in the direction θ=0 into electrical signals. The direction of the sound source that is perceived by the listener 24 will depend on the signals that are presented to the right and left headphones 20, 22.

Assume, for instance, that the output of microphone #0 is presented to the left headphone 20 and the output of microphone #4 is presented to the right headphone 22. The left ear 26 of the listener will receive the strong signal from the microphone #0 that is pointed directly towards the source and the right ear of the listener will receive the weak and time delayed signal of the microphone #4 that points away from the sound source. Therefore the listener perceives the sound source as located directly on his or her left. The direction of the perceived sound will be determined by the choice of the antipodal microphone pairs, and not by the orientation of the head of the listener. The directions that may be obtained by such a scheme are limited by the number of microphones 14 in the array 12. For an 8-microphone array 12, only 8 different sound source directions can be selected.

With suitable interpolation of the signals of adjacent microphones, any source direction may be presented to the listener. The external controller, or sound field rotation control device 16, determines the perceived sound source direction, and may optionally respond to the orientation of the listener's head.

Referring to FIG. 1, assuming the sound source is still in the direction θ=0, it is now the goal to present to the listener the sound in the direction θ=θ_{d} that does not coincide with the direction of a microphone 14. This goal cannot be achieved by presenting microphone signals directly to the left and the right headphones. Thus, an interpolation of microphone signals is necessary. A convenient way to describe the interpolation method is to introduce “virtual” headphones at the two antipodal directions at ±90 degrees of the desired sound direction. These virtual microphones VHₗ at direction θₗ and VHᵣ at direction θᵣ, are each bracketed by two adjacent microphones. The full-bandwidth interpolation of microphone signals adjacent to VHₗ or VHᵣ would produce undesirable sound artifacts because the distance to the adjacent microphones, and therefore the time delay from one microphone to the next, is too large for the range of audio frequencies of interest, typically 40 Hz to 20 kHz.

FIG. 3 through FIG. 6 schematically illustrate a linear filtering method 100 as applied to the rotation of a sound source. For each of the virtual headphones 26 and 28 (FIG. 4), the SRCD 16 will implement the linear filtering method 100, based on the angle θ_{d}, to combine the signals from the nearest microphone 14_{closest} and the next nearest microphone 14_{next-closest} (FIG. 3).

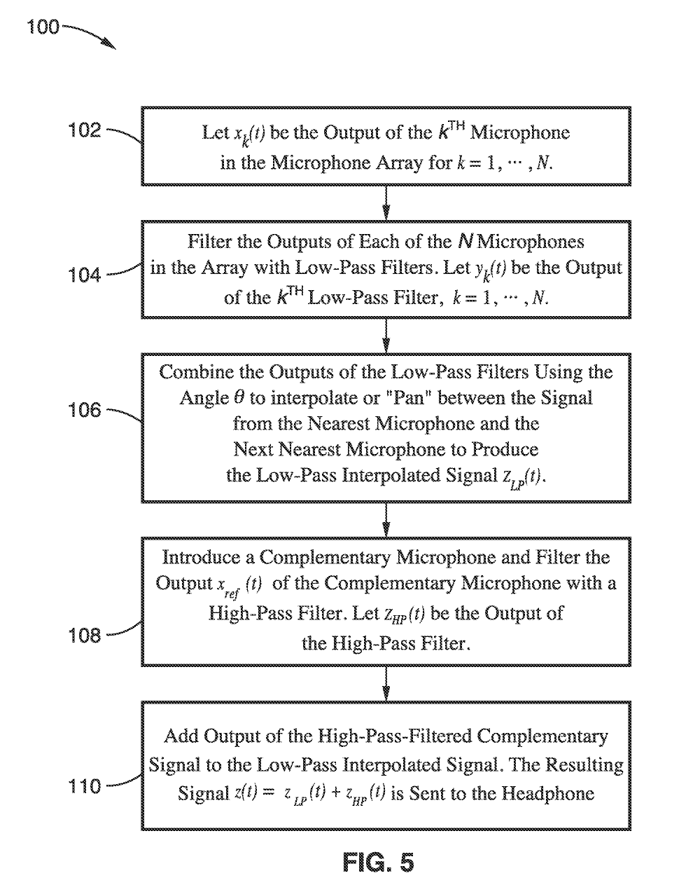

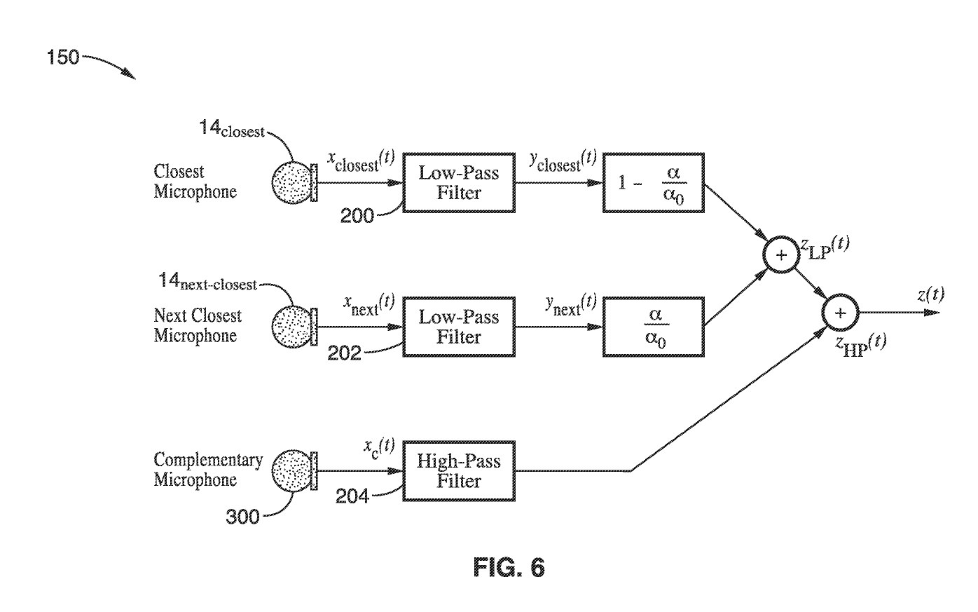

Method 100 takes advantage of the fact that humans are not sensitive to high-frequency interaural time difference. This property of human hearing suggests that the low-frequency components of the sound signals of adjacent microphones may be interpolated without introducing undesirable sound artifacts. For the high frequencies components, one of several complementary methods can be used, as described in U.S. Pat. No. 7,333,622 “Dynamic Binaural Sound Capture and Reproduction.” For sinusoids, interaural phase sensitivity falls rapidly for frequencies above 800 Hz, and is negligible above 1.6 kHz. Based on these observations, the signal interpolation method 100 for an 8-microphone array, as provided in FIG. 5, and shown schematically as method 150 in FIG. 6, is detailed as follows:

1. At step 102, let xₖ(t) be the output of the k^{th} microphone in the microphone array, k=1, . . . , N.

2. At step 104, the outputs of each of the N array 12 microphones 14 (e.g. 8) are filtered with low-pass filters (e.g. filters 200, 202) having a sharp roll off above a cutoff frequency ƒ_{c} in the range between approximately 1.0 and 1.5 kHz. Let yₖ(t) be the output of the k^{th} low-pass filter, k=1, . . . , N.

3. Next, at step 106, the outputs of filters are combined to produce the outputs z_{L}^{LP}(t) for the left virtual headphone 26 and z_{R}^{LP}(t) for the right virtual headphone 28. Considering the exemplary diagram 150 of FIG. 3 for the right virtual headphone signal Zᵣ(t), α is assigned to be the angle between the ray 40 to the right virtual headphone and the ray 42 to the closest microphone 14_{closest}, and α₀ is be the angle between the rays to two adjacent microphones (e.g., microphone 14_{closest} and microphone 14ₙₑₓₜ_{_{—}}_{closest} in this example). y_{closest}(t) is assigned to be the output of the low-pass filter 200 for the closest microphone, and yₙₑₓₜ(t) is assigned to be the output of the low-pass filter 202 for the next closest microphone, and let z_{R}^{LP}(t) be the desired combined output. Then the low-pass output for the right-ear is given by:

z_{R}^{LP}(t)=(1−α/α₀)y_{closest}(t)+(α/α₀)yₙₑₓₜ(t), with α≦α₀.

The low-pass output for the left ear is produced similarly and, since the processing elements for the left-ear signal are duplicative of those described above, they have been omitted from FIG. 5 and FIG. 6 for purposes of clarity.

4. At step 108, reference, or “complementary,” microphone 300 is introduced. Filter its output x_{ref}(t) with a complementary high-pass filter. Let Z^{HP}(t) be the output of this high-pass filter. The output x_{c}(t) of the complementary microphone 300 is filtered with a complementary high-pass filter 204. z_{HP}(t) is assigned to be the output of this high-pass filter.

5. Finally, at step 110, the output of the high-pass-filtered complementary signal is added to the low-pass interpolated signal and the resulting signal, z(t)=z_{LP}(t)+z_{HP}(t), is sent to the headphone. More specifically, if z_{L}(t) is the signal for the left virtual headphone and z_{R}(t) is the signal for the right virtual headphone, then z_{L}(t)=z_{L}^{LP}(t)+z^{HP} (t) and z_{R}(t)=z_{R}^{LP}(t)+z^{HP}(t).

There are several options in the selection and resulting signal processing of complementary microphone 300. In all cases, a high-pass filtered signal, resulting of the processing of the complementary microphones signals, is added to the low-pass signal as shown in the method 100/150 of FIG. 5 and FIG. 6. The complementary microphone 300 choices are as follows:

A. Use a separate microphone that is not part of the microphone array 12. Here, a separate microphone is used to pick up the high-frequency signals. For example, this could be an omni-directional microphone mounted at the top of the sphere. Although the pickup would be shadowed by the sphere for sound sources below the sphere, it would provide uniform coverage for sound sources in the horizontal plane.

B. Use one of the microphones in the array without consideration of the desired orientation of the virtual headphones.

C. Use one of the microphones in the array 12 that is dynamically switched according to the orientation of the virtual headphones.

D. Use the nearest microphone 14_{closest} in the array 12 and thus switch microphones as the orientation of virtual headphone crosses the mid-point between adjacent microphones.

E. Use two array microphones, such as adjacent microphones, and interpolate the signals of the two microphones. This option uses different complementary signals for the right ear and the left ear. For any given ear, the complementary signal is derived from the two microphones that are closest to that ear. This is very similar to the way in which the low-frequency signal is obtained. However, here it is the spectral magnitude of the two adjacent microphones that is interpolated. In this way, the sphere automatically provides the correct interaural level difference.

The systems 10, 50 and methods 100, 150 detailed above apply to captured live sound fields, to the reproduction of legacy recordings and to artificially created sound fields in a virtual auditory space. The virtual auditory space can be synthesized with measured room impulse responses or with models that combine head-related transfer function and acoustic models of rooms or acoustic spaces.

The motion of sound sources is greatly simplified by the systems and methods of the present invention. Consider an exemplary case of an isolated sound source that has either been captured by an array 12 of eight microphones 14 positioned on a cylindrical surface that approximates the size of the human head or obtained by synthesis in a virtual auditory space. Computationally, the rotation of this sound source about the listener's head requires only two interpolations of the low-frequency signals recorded or synthesized at the microphones and the addition at each ear of a complementary high-frequency signal. The operations of interpolation and summing are very simple and require minimal computation. Note also that the high-frequency signals take only eight discrete values for a full rotation of the sound source around the listener's head. Thus, rotation of the sound field can be done very rapidly and without significant latency. In addition, all modifications of the sound signals to account for a change of the distance between the sound source and the listener only requires the modification of the microphone signals that are interpolated or that contribute to the high-frequency complementary signal.

Special mention should be made of the case where the sound source motion is of a small increment that would result in a change of the interaural time difference that is less than the time between adjacent signal samples, 1/44100 of a second, for the most common consumer digital audio format. With the sound field orientation method 100 of the present invention, this small motion is simply achieved by the interpolation of the low frequencies of adjacent microphones, which is a continuous process independent of the sampling rate.

The systems and methods of the present invention also provide a substantial advantage in the creation of sound fields where a number of sound sources are combined and move independently so as to create a rich and complex sonic environment. Consider, for instance, a complex reference sound field that has been recorded by an array of eight microphones. This recorded sound field can be combined with additional sound fields by the superposition of the corresponding microphones signals. If an additional sound field corresponds to a moving sound source, then the effect of the motion of that sound source can be achieved by weighted sums of low-frequency and high-frequency signals of the corresponding microphones. Since the superposition of sound fields only requires a simple weighted sum of signals, complex sound fields can be created and modified by superposition without latency.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

From the discussion above it will be appreciated that the invention can be embodied in various ways, including the following:

1. A sound reproduction apparatus for determining the desired orientation of the listener's head in a sound field, comprising: (a) a processor; and (b) programming executable on said processor and configured for: (i) receiving input signals representative of output signals from a plurality of microphones; (ii) the plurality of microphones positioned to at a location to sample a sound field at points representing possible locations of a listener's left and right ears if said listener was positioned in said sound field at said location; and (iii) processing the input signals to generate a composite signal (iv) wherein the composite signal simulates a rotation of the sound field about the listener's head.

2. The apparatus of any of the preceding embodiments, wherein the composite signal comprises a binaural signal that is dynamically oriented independently of motion of the listener.

3. The apparatus of any of the preceding embodiments, wherein the binaural signal is configured to be received by an audio output device for playback to the listener.

4. The apparatus of any of the preceding embodiments, wherein processing the input signals further comprises: separating low-frequency components of said input signals from high-frequency components of said input signals based on a cutoff frequency that is a function of the distance between microphones; interpolating the low-frequency components of said input signals to produce low-frequency signal representing the low-frequency components associated with a location of a listener's ear; generating a complementary high-frequency signal by processing said high-frequency components as a function of the location of the listener's ear; forming a composite signal by adding said low-frequency signal to said high-frequency signal; forming the composite signal by adding the low-frequency signal to the high-frequency signal.

5. The apparatus of any of the preceding embodiments, wherein said binaural signal comprises a right ear composite signal and a left ear composite signal, and wherein processing the input signals further comprises: interpolating the low-frequency components of said input signals to produce a left ear low-frequency signal representing the low-frequency components associated with the location of the listener's left ear; interpolating the low-frequency components of said input signals to produce a right ear low-frequency signal representing the low-frequency components associated with the location of the listener's right ear; generating a complementary high-frequency signal for the left ear by processing said high-frequency components as a function of the location of the listener's left ear; generating a complementary high-frequency signal for right ear by processing said high-frequency components as a function of the location of the listener's right ear; forming the left ear composite signal by adding said left ear low-frequency signal to said left ear high-frequency signal; and forming the right ear composite signal by adding said right ear low-frequency signal to said right ear high-frequency signal.

6. An apparatus in any of the preceding embodiments, wherein the complementary high-frequency signal is obtained from the microphone signals by a complementing operation.

7. The apparatus of any of the preceding embodiments, wherein the programming is further configured for: interpolating low-frequency components of signals representative of an output from a nearest microphone and a next nearest microphone in relation to a desired position of the listener's left ear in said sound field; and interpolating low-frequency components of signals representative of an output from a nearest microphone and a next nearest microphone in relation to a desired position of the listener's right ear.

8. The apparatus of any of the preceding embodiments, further comprising a low-pass filter associated with each of said microphone output signals, the programming further configured for; interpolating outputs of said low-pass filters to produce an interpolated output signal for the listener's left ear, wherein said interpolated output signal comprises an interpolation of signals representative of an output from a nearest microphone and a next nearest microphone in relation to a desired position of the listener's left ear in said sound field; and interpolating outputs of said low-pass filters to produce an interpolated output signal for the listener's right ear, wherein said interpolated output signal comprises an interpolation of signals representative of an output from a nearest microphone and a next nearest microphone in relation to a desired position of the listener's right ear.

9. The apparatus of any of the preceding embodiments, wherein the low-pass filter comprises a left-ear high-pass filter configured to provide an output from a left-ear complementary microphone located in said sound field and a right-ear high-pass filter configured to provide an output from a right-ear complementary microphone located in said sound field, the programming further configured for: adding output from said left-ear high-pass filter to said interpolated output for the listener's left ear; and adding output from said right-ear high-pass filter to said interpolated output for the listener's right ear.

10. A sound reproduction method for determining the desired orientation of the listener's head in a sound field, comprising: receiving input signals representative of output signals from a plurality of microphones; the plurality of microphones positioned to at a location to sample a sound field at points representing possible locations of a listener's left and right ears if said listener was positioned in said sound field at said location; and processing the input signals to generate a composite signal; wherein the composite signal simulates a rotation of the sound field about the listener's head.

11. The method of any of the preceding embodiments, wherein the composite signal comprises a binaural signal that is dynamically oriented independently of motion of the listener.

12. The method of any of the preceding embodiments, further comprising receiving the binaural signal for playback to the listener.

13. The method of any of the preceding embodiments, wherein processing the input signals further comprises: separating low-frequency components of said input signals from high-frequency components of said input signals based on a cutoff frequency that is a function of the distance between microphones; interpolating the low-frequency components of said input signals to produce low-frequency signal representing the low-frequency components associated with a location of a listener's ear; generating a complementary high-frequency signal by processing said high-frequency components as a function of the location of the listener's ear; forming a composite signal by adding said low-frequency signal to said high-frequency signal; forming the composite signal by adding the low-frequency signal to the high-frequency signal.

14. The method of any of the preceding embodiments, wherein said binaural signal comprises a right ear composite signal and a left ear composite signal, and wherein processing the input signals further comprises: interpolating the low-frequency components of said input signals to produce a left ear low-frequency signal representing the low-frequency components associated with the location of the listener's left ear; interpolating the low-frequency components of said input signals to produce a right ear low-frequency signal representing the low-frequency components associated with the location of the listener's right ear; generating a complementary high-frequency signal for the left ear by processing said high-frequency components as a function of the location of the listener's left ear; generating a complementary high-frequency signal for right ear by processing said high-frequency components as a function of the location of the listener's right ear; forming the left ear composite signal by adding said left ear low-frequency signal to said left ear high-frequency signal; and forming the right ear composite signal by adding said right ear low-frequency signal to said right ear high-frequency signal.

15. The method of any of the preceding embodiments, wherein generating the complementary high-frequency signal comprises obtaining the microphone signals from a complementing operation.

16. The method of any of the preceding embodiments, further comprising: interpolating low-frequency components of signals representative of an output from a nearest microphone and a next nearest microphone in relation to a desired position of the listener's left ear in said sound field; and interpolating low-frequency components of signals representative of an output from a nearest microphone and a next nearest microphone in relation to a desired position of the listener's right ear.

17. The method of any of the preceding embodiments, further comprising: applying a low-pass filter to each of said microphone output signals; interpolating outputs of said low-pass filters to produce an interpolated output signal for the listener's left ear, wherein said interpolated output signal comprises an interpolation of signals representative of an output from a nearest microphone and a next nearest microphone in relation to a desired position of the listener's left ear in said sound field; and interpolating outputs of said low-pass filters to produce an interpolated output signal for the listener's right ear, wherein said interpolated output signal comprises an interpolation of signals representative of an output from a nearest microphone and a next nearest microphone in relation to a desired position of the listener's right ear.

18. The method of any of the preceding embodiments, wherein the low-pass filter comprises a left-ear high-pass filter configured to provide an output from a left-ear complementary microphone located in said sound field and a right-ear high-pass filter configured to provide an output from a right-ear complementary microphone located in said sound field, the method further comprising; adding output from said left-ear high-pass filter to said interpolated output for the listener's left ear; and adding output from said right-ear high-pass filter to said interpolated output for the listener's right ear.

19. A sound reproduction apparatus, comprising: (a) a signal processing unit; (b) said signal processing unit having an input for connection to a sound field rotation control device configured to generate a composite signal that simulates a rotation of a sound field about a listener's head; (c) said sound field rotation control device configured to receive input signals representative of output signals of a plurality of microphones positioned to sample said sound field at points representing possible locations of a listener's left and right ears if said listener's head were positioned in said sound field at the location of said microphones; (d) said sound field rotation control device having an output for presenting a binaural signal to an audio output device in response to the signal from said sound field rotation control device; (e) said sound field rotation control device configured to separate low-frequency components of said input signals from high-frequency components of said input signals based on a cutoff frequency that is a function of the distance between microphones; (f) said sound field rotation control device configured to interpolate the low-frequency components of said input signals and produce a left ear low-frequency signal representing the low-frequency components associated with the location of the listener's left ear; (g) said sound field rotation control device configured to interpolate the low-frequency components of said input signals and produce a right ear low-frequency signal representing the low-frequency components associated with the location of the listener's right ear; (h) said sound field rotation control device configured to produce a complementary high-frequency signal, obtained from the microphone signals by a complementing operation, for the left ear by processing said high-frequency components as a function of the location of the listener's left ear; (i) said sound field rotation control device configured to produce a complementary high-frequency signal, obtained from the microphone signals by a complementing operation, for the right ear by processing said high-frequency components as a function of the location of the listener's right ear; (j) said sound field rotation control device configured to form a left ear composite signal by adding said left ear low-frequency signal to said left ear high-frequency signal; (k) said sound field rotation control device configured to form a right ear composite signal by adding said right ear low-frequency signal to said right ear high-frequency signal; and (l) wherein said binaural signal comprises said right ear composite signal and said left ear composite signal.

20. The apparatus of any of the preceding embodiments: wherein said sound field rotation control device is configured to interpolate low-frequency components of signals representative of the output from a nearest microphone and a next nearest microphone in relation to the desired position of the listener's left ear in said sound field if said listener's head were positioned in said sound field at the location of said microphones; and wherein said signal processing unit is configured to interpolate low-frequency components of signals representative of the output from a nearest microphone and a next nearest microphone in relation to the desired position of the listener's right ear in said sound field if said listener's head were positioned in said sound field at the location of said microphones.

21. The apparatus of any of the preceding embodiments, wherein said sound field rotation control device comprises: a low-pass filter associated with each of said microphone output signals; programming executable on the signal processor and configured for interpolating outputs of said low-pass filters to produce an interpolated output signal for the listener's left ear, wherein said interpolated output signal comprises an interpolation of signals representative of the output from a nearest microphone and a next nearest microphone in relation to the desired position of the listener's left ear in said sound field; and programming executable on the signal processor and configured for interpolating outputs of said low-pass filters to produce an interpolated output signal for the listener's right ear, wherein said interpolated output signal comprises an interpolation of signals representative of the output from a nearest microphone and a next nearest microphone in relation to the desired position of the listener's right ear in said sound field.

22. The apparatus of any of the preceding embodiments, wherein said sound field rotation control device comprises: a left-ear high-pass filter configured to provide an output from a left-ear complementary microphone located in said sound field; a right-ear high-pass filter configured to provide an output from a right-ear complementary microphone located in said sound field; programming executable on the signal processor and configured for adding said output from said left-ear high-pass filter to said interpolated output for the listener's left ear; and programming executable on the signal processor and configured for adding said output from said right-ear high-pass filter to said interpolated output for the listener's right ear.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A sound reproduction apparatus for determining the desired orientation of the listener's head in a sound field, comprising:
(a) a processor; and
(b) programming executable on said processor and configured for:
(i) receiving input signals representative of output signals from a plurality of microphones;
(ii) the plurality of microphones positioned at a location to sample a sound field at points representing possible locations of a listener's left and right ears if said listener was positioned in said sound field at said location; and
(iii) processing the input signals to generate a composite signal;
(iv) wherein the composite signal simulates a rotation of the sound field about the listener's head.

2. An apparatus as recited in claim 1, wherein the composite signal comprises a binaural signal that is dynamically oriented independently of motion of the listener.

3. An apparatus as recited in claim 2, wherein the binaural signal is configured to be received by an audio output device for playback to the listener.

4. An apparatus as recited in claim 3, wherein processing the input signals further comprises:
separating low-frequency components of said input signals from high-frequency components of said input signals based on a cutoff frequency that is a function of a distance between microphones;
interpolating the low-frequency components of said input signals to produce low-frequency signals representing the low-frequency components associated with a location of a listener's ear;
generating a complementary high-frequency signal by processing said high-frequency components as a function of the location of the listener's ear;
forming a composite signal by adding said low-frequency signal to said high-frequency signal; and
forming the composite signal by adding the low-frequency signal to the high-frequency signal.

5. An apparatus as recited in claim 4, wherein said binaural signal comprises a right ear composite signal and a left ear composite signal, and wherein processing the input signals further comprises:
interpolating the low-frequency components of said input signals to produce a left ear low-frequency signal representing the low-frequency components associated with the location of the listener's left ear;
interpolating the low-frequency components of said input signals to produce a right ear low-frequency signal representing the low-frequency components associated with the location of the listener's right ear;
generating a complementary high-frequency signal for the left ear by processing said high-frequency components as a function of the location of the listener's left ear;
generating a complementary high-frequency signal for the right ear by processing said high-frequency components as a function of the location of the listener's right ear;
forming the left ear composite signal by adding said left ear low-frequency signal to said left ear high-frequency signal; and
forming the right ear composite signal by adding said right ear low-frequency signal to said right ear high-frequency signal.

6. An apparatus as recited in claim 4, wherein the complementary high-frequency signal is obtained from the microphone signals by a complementing operation.

7. An apparatus as recited in claim 5, wherein the programming is further configured for:
interpolating low-frequency components of signals representative of an output from a nearest microphone and a next nearest microphone in relation to a desired position of the listener's left ear in said sound field; and
interpolating low-frequency components of signals representative of an output from a nearest microphone and a next nearest microphone in relation to a desired position of the listener's right ear.

8. An apparatus as recited in claim 5, further comprising a low-pass filter associated with each of said microphone output signals, the programming further configured for:
interpolating outputs of said low-pass filters to produce an interpolated output signal for the listener's left ear, wherein said interpolated output signal comprises an interpolation of signals representative of an output from a nearest microphone and a next nearest microphone in relation to a desired position of the listener's left ear in said sound field; and
interpolating outputs of said low-pass filters to produce an interpolated output signal for the listener's right ear, wherein said interpolated output signal comprises an interpolation of signals representative of an output from a nearest microphone and a next nearest microphone in relation to a desired position of the listener's right ear.

9. An apparatus as recited in claim 8, wherein the low-pass filter comprises a left-ear high-pass filter configured to provide an output from a left-ear complementary microphone located in said sound field and a right-ear high-pass filter configured to provide an output from a right-ear complementary microphone located in said sound field, the programming further configured for:
adding output from said left-ear high-pass filter to said interpolated output for the listener's left ear; and
adding output from said right-ear high-pass filter to said interpolated output for the listener's right ear.

10. A sound reproduction method for determining the desired orientation of the listener's head in a sound field, comprising:
receiving input signals representative of output signals from a plurality of microphones;
the plurality of microphones positioned at a location to sample a sound field at points representing possible locations of a listener's left and right ears if said listener was positioned in said sound field at said location; and
processing the input signals to generate a composite signal;
wherein the composite signal simulates a rotation of the sound field about the listener's head.

11. A method as recited in claim 10, wherein the composite signal comprises a binaural signal that is dynamically oriented independently of motion of the listener.

12. A method as recited in claim 11, further comprising receiving the binaural signal for playback to the listener.

13. A method as recited in claim 12, wherein processing the input signals further comprises:
separating low-frequency components of said input signals from high-frequency components of said input signals based on a cutoff frequency that is a function of a distance between microphones;
interpolating the low-frequency components of said input signals to produce low-frequency signal representing the low-frequency components associated with a location of a listener's ear;
generating a complementary high-frequency signal by processing said high-frequency components as a function of the location of the listener's ear;
forming a composite signal by adding said low-frequency signal to said high-frequency signal; and
forming the composite signal by adding the low-frequency signal to the high-frequency signal.

14. A method as recited in claim 13, wherein said binaural signal comprises a right ear composite signal and a left ear composite signal, and wherein processing the input signals further comprises:
interpolating the low-frequency components of said input signals to produce a left ear low-frequency signal representing the low-frequency components associated with the location of the listener's left ear;
interpolating the low-frequency components of said input signals to produce a right ear low-frequency signal representing the low-frequency components associated with the location of the listener's right ear;
generating a complementary high-frequency signal for the left ear by processing said high-frequency components as a function of the location of the listener's left ear;
generating a complementary high-frequency signal for right ear by processing said high-frequency components as a function of the location of the listener's right ear;
forming the left ear composite signal by adding said left ear low-frequency signal to said left ear high-frequency signal; and
forming the right ear composite signal by adding said right ear low-frequency signal to said right ear high-frequency signal.

15. A method as recited in claim 13, wherein generating the complementary high-frequency signal comprises obtaining the microphone signals from a complementing operation.

16. A method as recited in claim 14, further comprising:
interpolating low-frequency components of signals representative of an output from a nearest microphone and a next nearest microphone in relation to a desired position of the listener's left ear in said sound field; and
interpolating low-frequency components of signals representative of an output from a nearest microphone and a next nearest microphone in relation to a desired position of the listener's right ear.

17. A method as recited in claim 16, further comprising:
applying a low-pass filter to each of said microphone output signals;
interpolating outputs of said low-pass filters to produce an interpolated output signal for the listener's left ear, wherein said interpolated output signal comprises an interpolation of signals representative of an output from a nearest microphone and a next nearest microphone in relation to a desired position of the listener's left ear in said sound field; and
interpolating outputs of said low-pass filters to produce an interpolated output signal for the listener's right ear, wherein said interpolated output signal comprises an interpolation of signals representative of an output from a nearest microphone and a next nearest microphone in relation to a desired position of the listener's right ear.

18. A method as recited in claim 17, wherein the low-pass filter comprises a left-ear high-pass filter configured to provide an output from a left-ear complementary microphone located in said sound field and a right-ear high-pass filter configured to provide an output from a right-ear complementary microphone located in said sound field, the method further comprising;
adding output from said left-ear high-pass filter to said interpolated output for the listener's left ear; and
adding output from said right-ear high-pass filter to said interpolated output for the listener's right ear.

19. A sound reproduction apparatus, comprising:
(a) a signal processing unit;
(b) said signal processing unit having an input for connection to a sound field rotation control device configured to generate a composite signal that simulates a rotation of a sound field about a listener's head
(c) said sound field rotation control device configured to receive input signals representative of output signals of a plurality of microphones positioned to sample said sound field at points representing possible locations of a listener's left and right ears if said listener's head were positioned in said sound field at the location of said microphones;
(d) said sound field rotation control device having an output for presenting a binaural signal to an audio output device in response to the signal from said sound field rotation control device;
(e) said sound field rotation control device configured to separate low-frequency components of said input signals from high-frequency components of said input signals based on a cutoff frequency that is a function of the distance between microphones;
(f) said sound field rotation control device configured to interpolate the low-frequency components of said input signals and produce a left ear low-frequency signal representing the low-frequency components associated with the location of the listener's left ear;
(g) said sound field rotation control device configured to interpolate the low-frequency components of said input signals and produce a right ear low-frequency signal representing the low-frequency components associated with the location of the listener's right ear;
(h) said sound field rotation control device configured to produce a complementary high-frequency signal, obtained from the microphone signals by a complementing operation, for the left ear by processing said high-frequency components as a function of the location of the listener's left ear;
(i) said sound field rotation control device configured to produce a complementary high-frequency signal, obtained from the microphone signals by a complementing operation, for the right ear by processing said high-frequency components as a function of the location of the listener's right ear;
(j) said sound field rotation control device configured to form a left ear composite signal by adding said left ear low-frequency signal to said left ear high-frequency signal;
(k) said sound field rotation control device configured to form a right ear composite signal by adding said right ear low-frequency signal to said right ear high-frequency signal;
(l) wherein said binaural signal comprises said right ear composite signal and said left ear composite signal.

20. An apparatus as recited in claim 19:
wherein said sound field rotation control device is configured to interpolate low-frequency components of signals representative of the output from a nearest microphone and a next nearest microphone in relation to the desired position of the listener's left ear in said sound field if said listener's head were positioned in said sound field at the location of said microphones; and
wherein said signal processing unit is configured to interpolate low-frequency components of signals representative of the output from a nearest microphone and a next nearest microphone in relation to the desired position of the listener's right ear in said sound field if said listener's head were positioned in said sound field at the location of said microphones.

21. An apparatus as recited in claim 20, wherein said sound field rotation control device comprises:
a low-pass filter associated with each of said microphone output signals;
programming executable on the signal processing unit and configured for interpolating outputs of said low-pass filters to produce an interpolated output signal for the listener's left ear, wherein said interpolated output signal comprises an interpolation of signals representative of the output from a nearest microphone and a next nearest microphone in relation to the desired position of the listener's left ear in said sound field; and
programming executable on the signal processing unit configured for interpolating outputs of said low-pass filters to produce an interpolated output signal for the listener's right ear, wherein said interpolated output signal comprises an interpolation of signals representative of the output from a nearest microphone and a next nearest microphone in relation to the desired position of the listener's right ear in said sound field.

22. An apparatus as recited in claim 21, wherein said sound field rotation control device comprises:
a left-ear high-pass filter configured to provide an output from a left-ear complementary microphone located in said sound field;
a right-ear high-pass filter configured to provide an output from a right-ear complementary microphone located in said sound field;
programming executable on the signal processing unit and configured for adding said output from said left-ear high-pass filter to said interpolated output for the listener's left ear; and
programming executable on the signal processing unit and configured for adding said output from said right-ear high-pass filter to said interpolated output for the listener's right ear.
